(19) United States
(12) Patent Application Publication
(10) Pub. No.: US 2004/0251651 A1
(43) Pub. Date: Dec. 16, 2004

(54) Vehicle suspension, vehicle control method and vehicle control apparatus

(75) Inventors: Tatsuyuki Yamamoto, Chiyoda-ku (JP); Takehiko Kowatari, Chiyoda-ku (JP)

Correspondence Address: CROWELL & MORING LLP, INTELLECTUAL PROPERTY GROUP, P.O. BOX 14300, WASHINGTON, DC, 20044-4300, US

(73) Assignee: Hitachi, Ltd.

(21) Appl. No.: 10/815,770

(22) Filed: Apr. 2, 2004

(30) Foreign Application Priority Data
Apr. 4, 2003 (JP) 2003-101745

(51) Int. Cl. B60G 3/12

(52) U.S. Cl. 280/124.128

(57) ABSTRACT

A new system of suspension and car body control art in a car of a wheel-in motor system for variably controlling a spring and a damper according to a road state and controlling car body posture, thereby improving comfortableness to ride in.

A wheel-in motor which is installed in a wheel and has an output shaft rotating with the wheel is provided. In an arm capable of swinging in the longitudinal direction of the car body, which is used for each suspension, one end thereof is fixed to a car body with a pivot, and the other end is connected to the wheel-in motor so as to rotate relatively to the output shaft.

The car body is supported with the arms. By controlling the revolution speed and torque of each wheel-in motor of the front and rear wheels during traveling of the car and using the swing motion of the arm in the longitudinal direction of the car body, the posture of the car body is controlled.

### BACKGROUND OF THE INVENTION

The present invention relates to a vehicle suspension for suspending a body of a vehicle, a vehicle control method and a vehicle control apparatus for controlling a vehicle posture with the suspension, for example, suitable for an electric car.

In a conventional electric car, for example, as disclosed in Japanese Application Patent Laid-Open Publication No.11-262101, a wheel-in motor system is published. In this system, each motor for driving each wheel is installed in the wheel. Such motor is called as wheel-in motor. The wheel-in motor system has an advantage that the power space such as a propeller shaft is little required on a chassis.

As an existing system for supporting each wheel with a wheel-in motor, as a typical one, for example, an independent suspension system of a wishbone system is conceivable. Each arm of the suspension system is directed in the lateral direction of the car body to support the wheel.

### SUMMARY OF THE INVENTION

In a system that each motor unit is incorporated into each wheel such as a wheel-in motor, the non-suspended weight is increased. Therefore, the comfortableness to ride in the car of the system is inferior to that of other car drive train systems, the system is desired to be improved. However the conventional suspension system cannot cope with such a problem sufficiently. Further, it does not have a consideration for controlling the vehicle posture (the posture of car body) depending on the state of roads.

An object of the present invention, particularly in the vehicle using the wheel-in motor system as the drive train unit, is to provide a new system of suspension and vehicle control which can improve the comfortableness to ride in. The improvement is realized by controlling variably springs and dampers of the suspension and controlling the vehicle posture (car body posture) according to the state of roads.

The present invention, to accomplish the above object, is basically structured as described below.

The invention relates to the suspension, and adopts a swing type arm as each wheel support arm of the suspension. Here, the swing type arm is an arm having one end attached to the car body with a pivot so as to swing in the longitudinal direction of the car. Another end (it is an opposite side of the pivot: a free end of the arm) of the arm and the wheel-in motor are connected together so that the arm can freely turn round the output shaft of the wheel-in motor.

Further, the following vehicle control method for controlling the vehicle posture (the posture of a car body) is proposed. A suspension having the above structure is used for the independent suspension system of the vehicle. And the vehicle posture is controlled by controlling at least the revolution speed and torque of each wheel-in motor of the front wheels and rear wheels, and furthermore, by utilizing the swing action of each arm in the longitudinal direction of the car body.

Furthermore, the vehicle control apparatus is proposed as follows. The apparatus comprises the aforementioned swing type arms and wheel-in motors, and an arm angle control unit for controlling each arm angle in the swing direction of the arm by controlling the revolution speed and torque of the wheel-in motors. Thereby the apparatus can change the incline angle of each arm for supporting each wheel.

### BRIEF DESCRIPTION OF THE DRAWINGS

FIG. 1 is a longitudinal cross sectional view showing the inner structure of only the suspension of one wheel of an independent suspension system for vehicle relating to an embodiment of the present invention,

FIGS. 2(a) and 2(b) are drawings showing the basic structure and the principle of the present invention,

FIGS. 3(a), 3(a) and 3(c) are drawings showing a vibration absorption mechanism of a suspension applied to the aforementioned embodiment,

FIG. 4 is an inner structural diagram showing an example of a variable damper used in the vibration absorption mechanism,

FIGS. 5(a) and 5(b) are drawings showing a vehicle with four wheels having the suspensions relating to the aforementioned embodiment, and FIG. 5(a) is a drawing viewed from the side of the vehicle, and FIG. 5(b) is a drawing viewed in the longitudinal direction,

FIGS. 6(a) and 6(b) are an drawings showing the motions of the vehicle of the present invention,

FIG. 7 is a drawing showing one of suspensions relating to another embodiment of the present invention,

FIG. 8 is an illustration showing motions (vehicle postures) of the vehicle controlled by the present invention,

FIG. 9 is an illustration showing motions of the vehicle controlled by the present invention,

FIG. 10 is an illustration showing motions of the vehicle controlled by the present invention,

FIG. 11(a),(b) are illustrations showing motions of the vehicle controlled by the present invention,

FIG. 12(a), (b), (c) and (d) are illustrations showing motions of the vehicle controlled by the present invention,

FIG. 13 is a drawing showing another embodiment,

FIG. 14 is a schematic view of a controller used in the aforementioned embodiment, and

FIG. 15 is a drawing showing the behavior of the spring of the suspension at the time of vehicle control shown in FIG. 12.

### DETAILED DESCRIPTION OF THE INVENTION

(Description of the Preferred Embodiments)

The embodiments of the present invention will be explained with reference to the accompanying drawings.

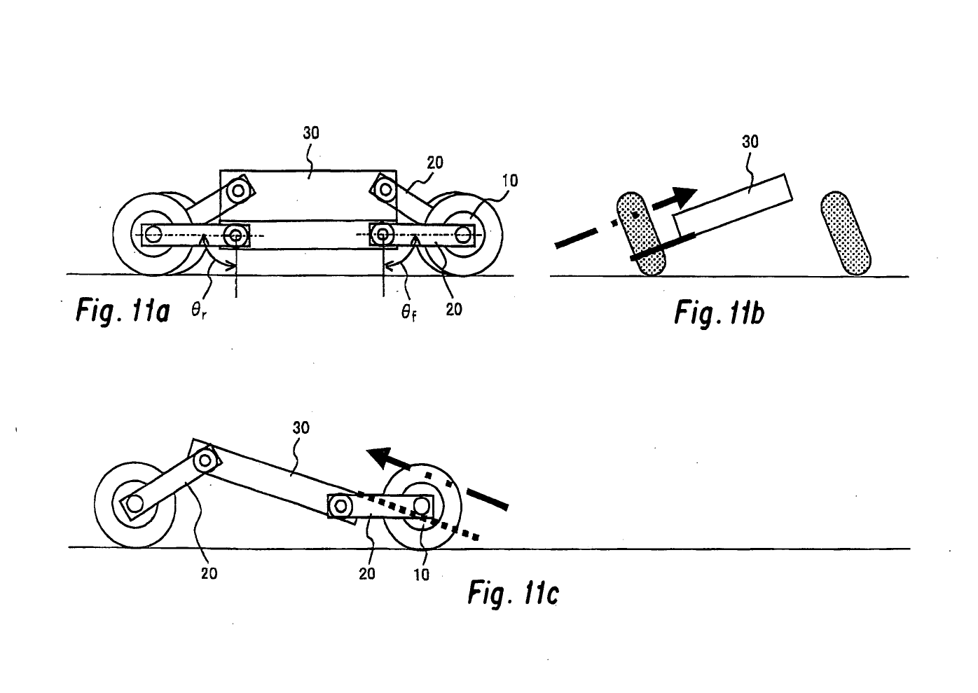

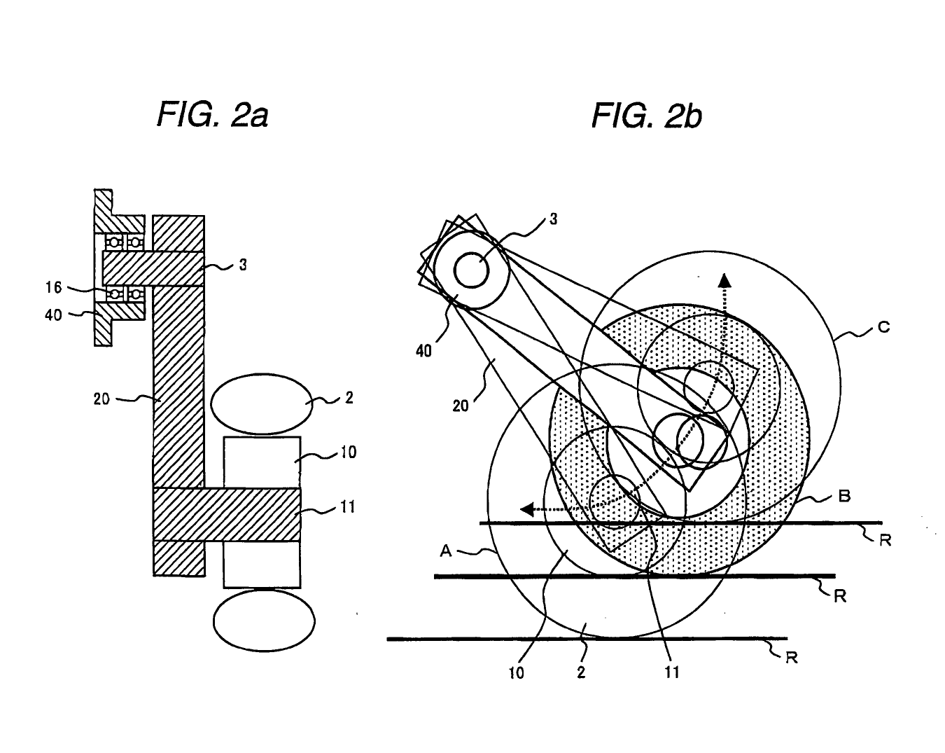

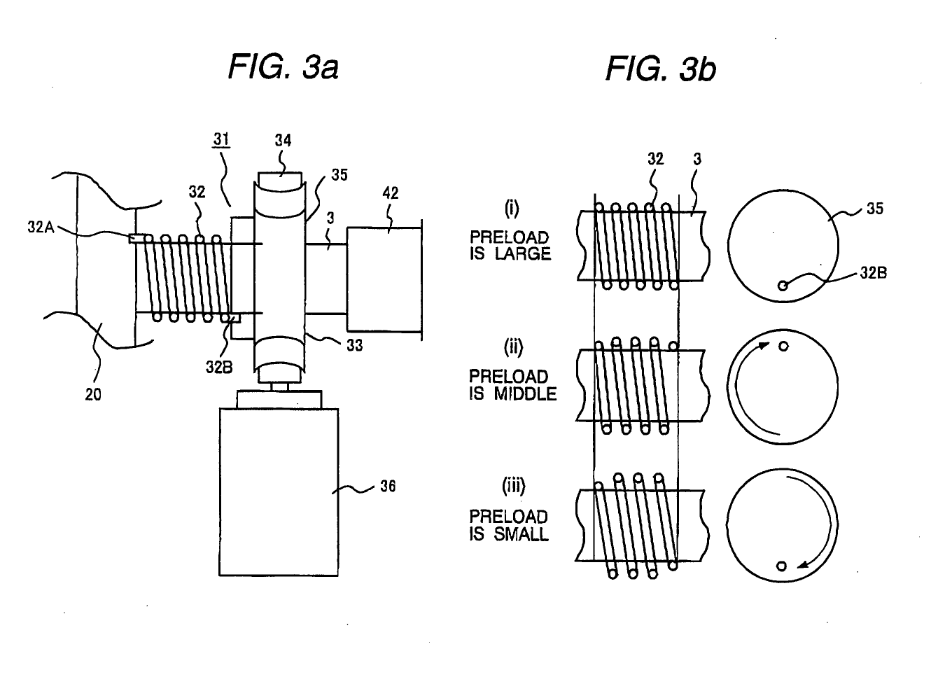

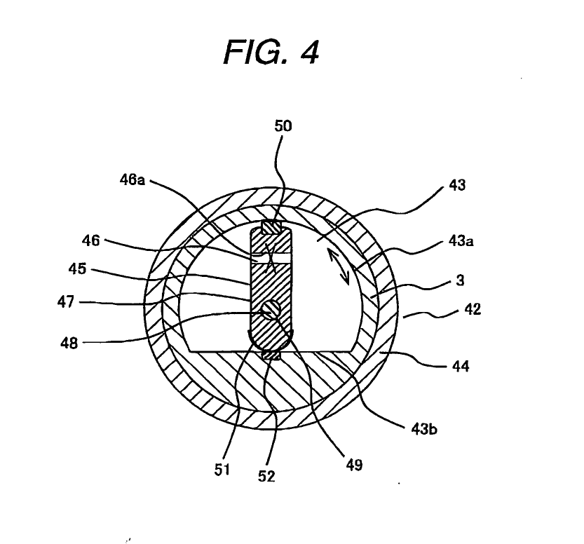

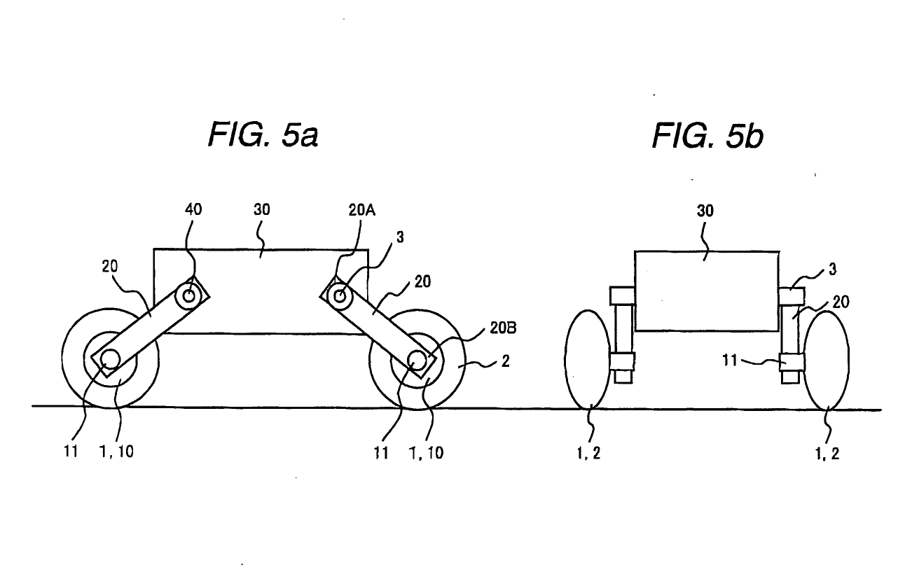

FIG. 1 is a longitudinal cross sectional view showing the inner structure of only the suspension of one wheel of an independent suspension system for vehicle relating to an embodiment of the present invention. The suspension shown in FIG. 1 is a drawing viewed in the longitudinal direction of a car body 30 (refer to FIG. 5(b)). FIGS. 2(a) and 2(b) are drawings showing the basic structure and principle thereof, and FIG. 3(a) is a drawing showing the vibration absorption mechanism of the suspension applied to the this embodiment, and FIG. 3(b) is an illustration showing the states that the load to be applied to a coil spring used on the vibration absorption mechanism is changed. FIG. 4 is an inner structural diagram showing an example of a variable damper used in the vibration absorption mechanism.

FIGS. 5(a) and 5(b) are drawings showing a vehicle with four wheels having the suspensions relating to the embodiment, and FIG. 5(a) is a drawing viewed from the side of the vehicle, and FIG. 5(b) is a drawing viewed in the longitudinal direction.

Each suspension relating to this embodiment, basically as shown in FIG. 1, has a wheel-in motor 10 and an arm 20 supporting the car body 30 and is structured as described below.

The wheel-in motor 10 is installed in each wheel of a vehicle. In the arm 20, to swing in the longitudinal direction of the vehicle, one end 20A thereof is attached to the car body 30 with a pivot 3, and another end 20B is connected to the wheel-in motor 10 so as to freely turn relatively to an output shaft 11 of the wheel-in motor 10.

The arm 20 can swing (turn) around the pivot 3, so that it may be referred to a swing arm.

At the outside face of one end 20B of the arm 20, a sleeve 21 projecting outward is integrately formed with the arm. The inside of one end 20B thereof has a hall 22 leading to the sleeve 21.

The output shaft 11 is inserted through the sleeve 21 with bearings 4, so that the arm 20 and the output shaft 11 are connected together so as to can rotate relatively. One end 11A of the output shaft 11 is positioned in the hall 22 and a brake disk 5 is attached thereon.

Further, a brake pad 6 for clamping the brake disk 5 by electromagnetic force and an electromagnetic actuator 7 thereof are provided at the hall 22. The pad 6 and actuator 7 of an electromagnetic brake 8 are held to the inner surface of the hall 22 with a holder 9.

The wheel-in motor 10 is comprised of, for example, a synchronous rotary machine (for example a synchronous motor or synchronous motor-generator) of a permanent magnet type, and is structured as described below. A coil which is a stator 12 of the wheel-in motor 10 is fixed on the outer surface of the sleeve 21. Each wheel 1 is connected with the output shaft 11, and a permanent magnet which is a rotator 13 is fixed on the inner surface of the wheel 1.

The revolution speed and torque of the wheel-in motor 10 are controlled by controlling variably the frequency and current (voltage) of the motor 10 by an inverter (not shown in the drawing). Further, the wheel-in motor can perform both motoring and regenerative braking. Furthermore, electric energy generated by regenerative braking is charged in a storage battery (not shown in the drawing).

Numeral sign 14 indicates a motor harness, and sign 15 indicates a brake harness. Bearings 16 are fixed to the car body (chassis) 30, and the pivot 3 fixed to the arm 20 is supported by the bearings 16.

A spring unit 31 and a damper 42, which are functioned as a vibration suppression mechanism of the vehicle, are attached to the pivot 3. The spring unit 31 functions as a cushion element for vibration in the vertical direction of the wheel. The damper (shock absorber) 42 functions as a proper vibration damping element.

An example of the spring unit 31 of this embodiment is shown in FIG. 3.

The spring unit 31 has a coil spring 32 arranged around the pivot 3 and a mechanism (preload mechanism) 33 for changing the load to be applied to the coil spring 32.

The coil spring 32 performs a spring action by twisting for the swing motion of the arm 20.

The preload mechanism 33 is comprised of, for example, a worm gear 34, a worm wheel 35, and a preload control motor 36. One end 32A of the coil spring 32 is attached to the swing arm 20 and another end 32B is attached to the worm wheel 35.

When the motor 36 is rotated forward and backward, the worm wheel 35 is rotated, and the position of the end 32B of the spring is changed depending on the rotation position thereof. Thereby, as shown in FIG. 3(b), the torsion force (the preload applied to the coil spring beforehand) of the spring 32 can be changed, thus the degree of the cushion can be controlled.

In FIG. 3(b), (i) indicates a great (strong) preload, (ii) a neutral preload, and (iii) a small (weak) preload.

In FIG. 4, as a damper 42, for example, a hydraulic variable damper of a rotary type is shown.

In the damper 42 in this embodiment, an oil chamber 43 is formed at one end of the pivot 3. The one end of the pivot 3 is inserted into a fixed element (cylinder) 44 of the car body in the airtight state, and a variable orifice mechanism 45 is fixed to inner end surface of the cylinder 44.

The oil chamber 43 is formed by an inner surface 43a like an arc and an inner surface 43b like a cord, damper oil is filled up therein.

The variable orifice mechanism 45 is formed on the inner end face (the end face of the pivot opposite to the oil chamber 43) of the cylinder 44. The variable orifice mechanism 45 has a block 47 formed on the inner end face of the cylinder 44, an orifice 46 formed in the block 47, and a variable restrictor (variable orifice member) 46a like an iris for adjusting the inner diameter of the orifice 46 by an actuator (not shown in the drawing).

The variable orifice mechanism 45 is positioned in the oil chamber 43. The block 47 has a length in correspondence to the diameter direction of the pivot 3. An axial hole 49 is provided at the block 47 in the axial direction of the pivot. A rotary shaft 48 provided at the center of the end face of the pivot 3 rotatably is inserted into the axial hole. Both ends of the block 47 have ark faces, and seal members 50 and 51 are attached on the arc faces. When the oil chamber 43 rotates in the direction of the arrow together with the pivot 3, the inner ark surface 43a of the oil chamber rotates in contact with the seal member 50. The chord surface 43b has a movable seal 52 making contact with the seal member 51 at its center. When the chord surface 43b rotates, the movable seal 52 makes contact with the circular seal member 51.

The oil chamber 43 is partitioned into two chambers by the block 47. The area ratio of the two chambers varies with the rotation of the pivot 3. Thereby, oil pressure is generated in one oil chamber (the area is reduced), and a part of the oil flows into another oil chamber (the area is increased) through the orifice 46, thus the damper action is performed.

The hardness (damping coefficient) of the damper can be changed by adjusting the orifice diameter by the variable restrictor 46a.

The variable damper and the variable spring mechanism of the vibration absorption mechanism are not limited to those of this embodiment, and various structures can be considered. The variable damper and the variable spring mechanism functions a control mechanism for controlling a response of the swing motion of the arm 20.

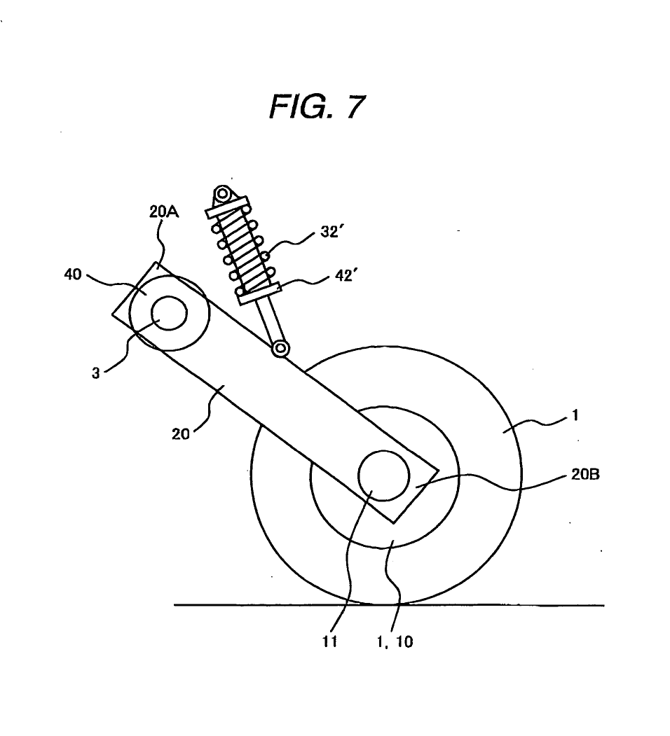

FIG. 7 shows another example of the vibration absorption mechanism. The connection structure of the swing arm 20 and wheel-in motor 10 of the suspension is the same as that of the aforementioned embodiment shown in FIG. 1. In this embodiment, the coil spring 32′ and the damper 42′ of the cylinder type are installed between the car body and the swing arm 20. Also in this embodiment, the coil spring 32′ and the damper 42′ can be structured variably.

The suspension structured as above-mentioned embodiment is used for independent suspension systems of various electric cars as shown in FIG. 5.

When the suspension relating to the embodiment is installed to the independent suspension systems, the vehicle (car body) can be controlled as follows.

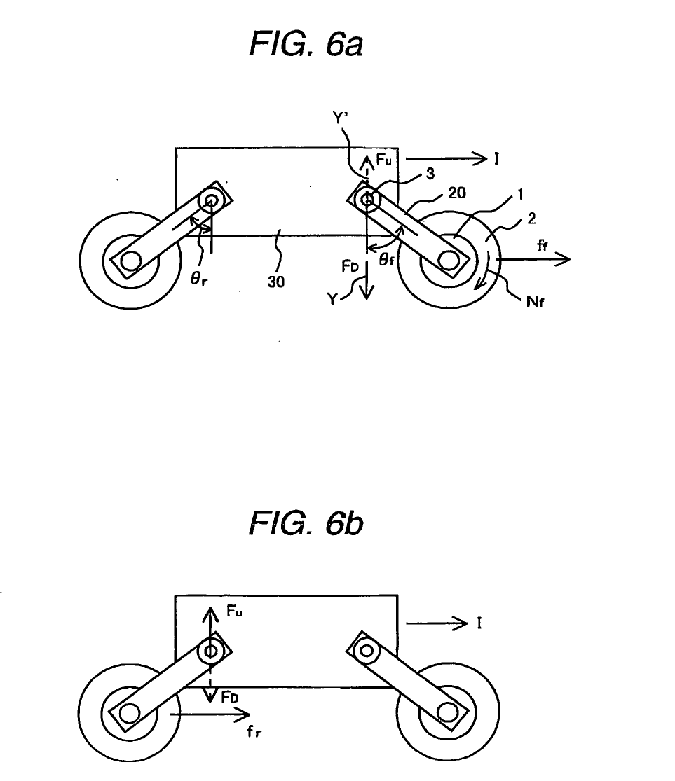

Firstly, the basic behaviors thereof will be explained by referring to FIG. 2(b) and FIGS. 6(a) and 6(b).

Numeral sign 40 indicates a fixed central point (fulcrum) of the swing arm 20 on the vehicle.

For example, the suspension shown in FIG. 2(b) is a one on the front wheel side. Further, a symbol R indicates road surfaces on the same level.

When the orifice 46 of the damper 42 is completely closed, the damper turns into the state of rigid body. Thereby the arm 20 is locked so as not to swing. When the orifice 46 is opened, the damper 42 functions, and as the orifice 46 is enlarged, the damping force is increased. Further, as the damping force is increased, the swing motion can be easily performed (The response of the swing motion turn to a large state).

Here, the state of the arm angle θ (the angle formed by the perpendicular line at fulcrum 40 and axis of the swing arm 20) in the traveling state, which is indicated by the symbol B shown in FIG. 2(b), is assumed as standard θo. In this state, let's assume that the swing motion of the arm 20 is made possible by unlocking the arm and that the torque of the wheel-in motor 10 is increased.

Here, let's assume that the torque of the wheel-in motor 10 of each front wheel is made to increase. In this case, acceleration is generated in each front wheel by an increase of the torque of the wheel-in motor 10, the number (speed) of revolution Nf of the front wheel is increased. And when the traveling speed ff of the front wheel is increased more than the inertia speed I of the car body 30 (refer to FIG. 6 (a)) (I<ff), each arm 20 of the front wheel side swings ahead as shown by the symbol C, so that the arm angle θ is increased. And, as indicated by the solid line Y of the arrow shown in FIG. 6(a), the motor torque reaction force, which is generated based on the difference between the traveling speed ff of the front wheel and the inertia speed I of the car body, acts on the arm 20 (this reaction force acts as press-down force FD of the car body 30 on the front wheel side). Thereby the height of the car body turns to a low state on the front wheel side.

Inversely, let's assume that the torque of the wheel-in motor 10 of each front wheel is reduced from the state B shown in FIG. 2(b).

In this case, the traveling speed of each front wheel is reduced. And when the traveling speed ff of the front wheel is reduced lower than the inertia speed I of the car body 30 (refer to FIG. 6(b)) (I>ff), each arm 20 of the front wheel side, as shown by the symbol A of FIG. 2(b), swings behind so that the arm angle θ is reduced. In this case, as indicated by the dotted line Y′ of the arrow shown in FIG. 6(a), the motor torque reaction force, which is generated based on the difference between the traveling speed ff of the front wheels and the inertia speed I of the car body, acts on the arm 20 (this reaction force acts as press-up force Fu of the car body 30 on the front wheel side). Thereby, the height of the car body turns to a high state on the front wheel side.

In the case of the rear wheels, inversely to the case of the front wheels, when the traveling speed f_{R} of each rear wheel is increased higher than the inertia speed I of the car body 30, each arm 20 of the rear wheel side swings ahead so that the arm angle θ is reduced. And, as indicated by the solid line of the arrow shown in FIG. 6(b), the motor torque reaction force, which is generated based on the difference between the traveling speed f_{R} of the rear wheel and the inertia speed I of the car body, acts on the arm 20 of the rear wheel (this reaction force acts as press-up force Fu of the car body 30 on the rear wheel side). And the height of the car body turns to a high state on the rear wheel side.

Further, when the torque of the wheel-in motor of each rear wheel is reduced, the traveling speed f_{R} of the rear wheel is reduced. And when the traveling speed f_{R} is reduced lower than the inertia speed of the car body 30, the arm 20 swings behind so that the arm angle θ is increased. In this case, as indicated by the dotted line of the arrow shown in FIG. 6(b), the motor torque reaction force, which is generated based on the difference between the wheel speed of the rear wheel side and the inertia speed of the car body, acts on the arm 20 (this reaction force acts as press-down force FD on the rear wheel side of the car body). And the height of the car body turns to a low state on the rear wheel side.

It is possible for such vehicle posture controls to maintain the car body horizontally in even the following road surface state at the traveling time.

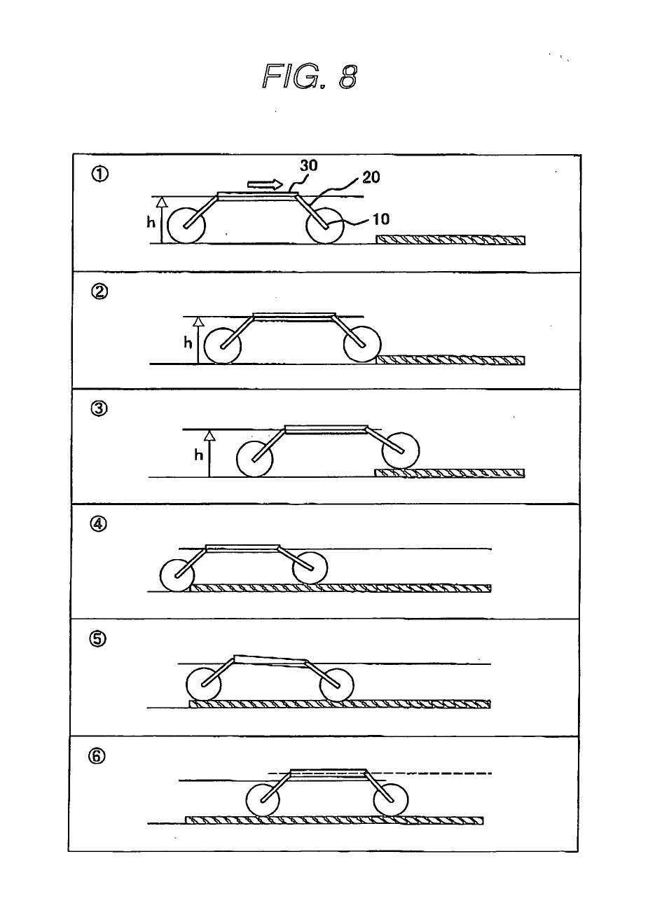

FIG. 8 shows, for example, an example of vehicle posture control when there is a difference in level where the load surface turns high suddenly on a traveling road.

(1) shown in FIG. 8 indicates a stationary traveling state. In this case, the damper 42 and the spring 32 of each arm 20 of the front and rear wheels are set to normal hardness, and the angles θf and θr of each arm 20 are set to a predetermined angle θo, and the traveling speeds ff and fr of the front and rear wheels are controlled so as to reach a target value at a uniform speed. In this case, the controller controls so that the revolution speeds Nf and Nr of the front and rear wheels become equal, thereby controls the traveling speeds of the front and rear wheels to a uniform speed. In this stationary traveling state, the car body 30 is kept at a target horizontal height of h.

(2) shown in FIG. 8 indicates a state that the front wheels approach a difference in road level(a change from low level to high level). In this case, since the traveling load is increased, the speed of the front wheels is apt to be reduced (reduction in the speed of revolutions of the front wheels). However, the torque of the front wheels is increased so as to keep the speed ff of the front wheels (the number of revolutions of the front wheels). Namely, the current of the wheel-in motor is increased so that the speed of revolutions of the front wheels reaches the target value, and the motor torque is increased. Further, in correspondence to the torque increase, for example, the damper 42 and the spring 32 of the front wheels are made softer than the normal hardness. With respect to the rear wheels, to prevent variations in the height of the rear wheel side of car body, the damper and spring are controlled so as to turn to a hard state.

(2) shown in FIG. 8 indicates the state that the torque is increased to keep the speed of the front wheels and that the front wheels run on to the road surface with a difference in level. And, as shown in (3) in FIG. 8, in the state that the front wheels run on to the difference in road level, the torque of the front wheels is increased until the car body turns to horizontal, and the traveling speed ff of the front wheels is increased (the torque current of the front wheel-in motor is increased). Namely, immediately after the front wheels run on, the torque of the front wheel-in motor is increased, and the traveling speed ff of the front wheels exceeds the inertia speed I of the car body, thus the swing arm 20 performs the swing motion so that the arm angle θf is increased. At this time, the reaction force of the motor torque presses down the car body 30 on the front wheel side. However, since the front wheels run on to the difference in road level, the height of the front wheel side of the car body is balanced with the height of the rear wheel side, thus the height of the car body is kept horizontal. After this swing motion of the arm 20, the damper and spring of the front wheels are returned to the normal state from the soft state.

Next, as shown in (4) in FIG. 8, the rear wheels approach the difference in road level. In this case, the control pattern (hereinafter, referred to as the “trace pattern”) for running-on of the front wheels on the level difference, which is performed previously, is learned beforehand. And the current of the rear wheel-in motors is increased and controlled (the motor torque is controlled to increase) according to the trace pattern, and the traveling speed of the rear wheels is prevented from reduction, and the speed of the rear wheels is held. By such control for the torque of the rear wheels, the damper and spring of the rear wheels are held in the normal state.

Immediately after the rear wheels run on ((5) in FIG. 8), since the load is reduced, the speed of the rear wheels is apt to increase more than the target value (the speed of revolutions of the rear wheels increases). In order to prevent from its increase, the torque of the rear wheels (the torque current of the wheel-in motor) is reduced so that the speed of the rear wheels (the number of revolutions of the rear wheels) reaches the target value. On the other hand, with respect to the front wheels, in order to put the car body into the horizontal state, the front wheel torque of the wheel-in motor is reduced so as to return the arm angle θf of the front wheels to the target value θo. Namely, since the torque of the front wheels is reduced, the speed of the front wheels is reduced, and the arm 20 performs the swing motion so that the arm angle θf is reduced ((5) in FIG. 8).

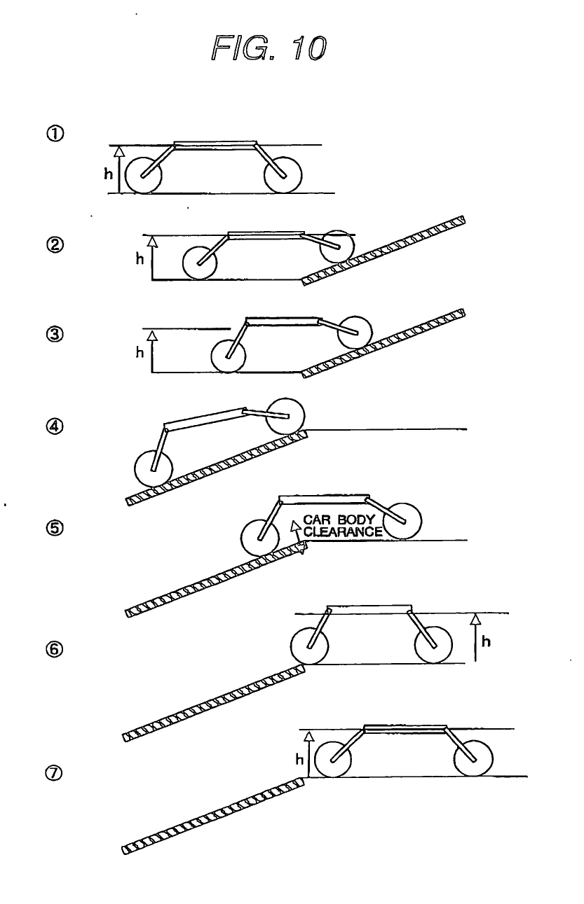

At this time, the reaction force of the motor torque presses up the front wheel side of the car body 30. However, the height of the front wheel side of the car body is lowered at the point of time when the front wheels run on to the difference in road level, so that the lowering and the aforementioned press-up cancel each other, thus the height of the front wheel side of the car body is balanced with the height of the rear wheel side, and the height of the car body is kept horizontal. After such a swing motion of the arm 20, the damper and spring of the front wheels are returned from the soft state to the normal state. Thereafter, as shown in (6) in FIG. 10, the car is returned to the stationary traveling control.

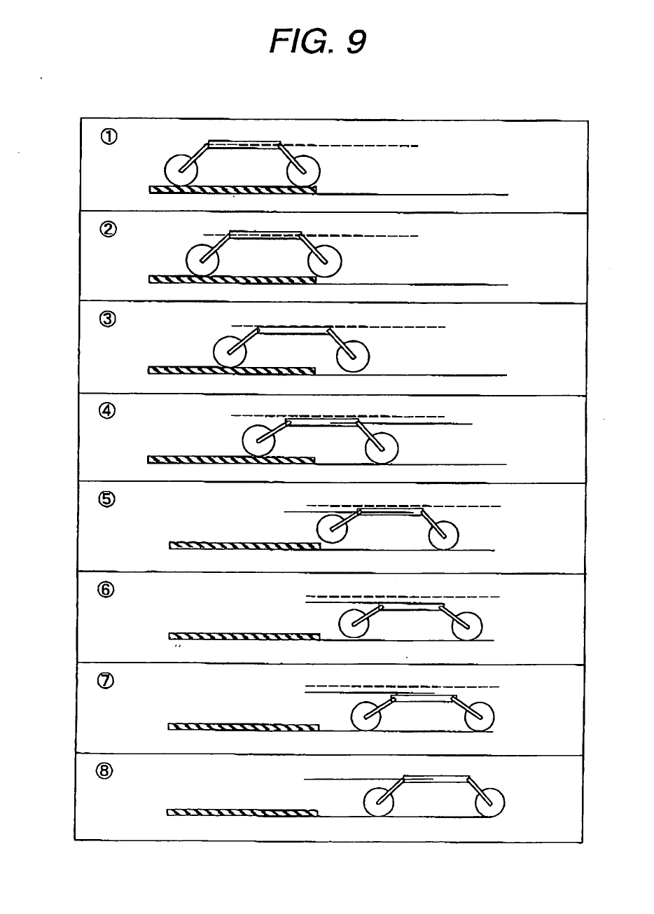

FIG. 9 shows an example of the vehicle posture control when there is a difference in road level where the road surface is lowered on a traveling road.

(1) shown in FIG. 9 indicates a stationary traveling state. This case is the same as (1) in FIG. 8 mentioned above.

(2) shown in FIG. 9 indicates a state that the front wheels approach the difference in road level (a change from high level to low level). In this case, the front wheels are momentarily put into the state of not landing on the ground, so that although the torque (current) of the front wheel-in motor is almost fixed, the number of revolutions Nf of the front wheels is increased. From the relationship between the number of revolutions of the motor (the number of revolutions of the front wheels) and the motor torque (motor current), the state of not landing of the front wheels is detected. Further, the torque of the rear wheels (rear wheel motor current) is reduced to hold the car body horizontally. Further, to make the swing motion of the rear wheel arm 20, the damper 42 and the spring 32 of the rear wheels are put into the soft state. By doing this, the rear wheel speed fr is reduced by a reduction in the torque of the rear wheels, and a difference between the traveling speed fr of the rear wheels and the inertia speed F of the car body is generated. The rear wheel arm performs the swing motion so as to increase the rear wheel arm angle θr by the reaction force of the motor torque. Such a reduction control for the torque of the rear wheels is performed until the car body turns to horizontal ((3) in FIG. 9).

After such a swing operation of the rear wheel arm 20, the damper and spring of the rear wheels are returned to the normal state from the soft state.

And, after detection of landing of the front wheels (after variations in the front wheel speed are detected), the torque of the front wheels is increased to keep the speed at the time of stationary traveling ((4) in FIG. 9).

Next, as shown in (5) in FIG. 9, the rear wheels approach the difference in road level. In this case, on the basis of the trace pattern at the time of landing of the front wheels performed previously, the arrival time t until the rear wheels will turn to the not-landing state and the not-landing time are presumed, and while the rear wheels are not-landing (the not-landing time zone), the torque of the rear wheels is reduced and the number of revolutions Nr of the rear wheels is kept almost constant.

Thereafter, for absorbing the shock in the vertical direction at the time of landing of the rear wheels, on the basis of the learned trace pattern of the front wheels, the landing time of the rear wheels is presumed, and the torque of the front wheels is increased simultaneously with the presumed landing time of the rear wheels. And, the damper and spring of the front wheels are put into the soft state from the normal state. By the increase in the motor torque, the traveling speed of the front wheels is increased, and the arm 20 performs the swing motion so as to increase the arm angle θf. The angle θf is controlled so as to close to the angle θr under the control of the front wheels. As a result, the car body height is lowered so as to be horizontal simultaneously with landing of the rear wheels, so that the comfortableness to ride in is improved.

Thereafter, from variations in the speed of the rear wheels due to landing of the rear wheels, the landing is detected, and the torque of the rear wheels is returned to the one at the time of stationary traveling, and the target speed is kept ((7) in FIG. 9).

Next, the torque of the rear wheels is increased, and the speed of the rear wheels is increased, and the height of the rear wheel side of the car body is recovered by a reduction in the arm angle θ of the rear wheels. And simultaneously the torque of the front wheels is reduced, and the speed of the front wheels is reduced, and the arm angle θf of the front wheels is reduced similarly to θr, and the height of the front wheel side of the car body height is recovered ((8) in FIG. 9). By doing this, the car body is kept horizontal and the height of the car body is recovered to the target value.

FIG. 10 shows an example of the vehicle posture control suited to go up a slope, particularly a steep slope.

(1) shown in FIG. 10 indicates stationary traveling on a flat road. The wheel control in this case is similar to (1) shown in FIGS. 8 and 9.

As shown in (2) in FIG. 10, when the front wheels approach an inclined road surface, to keep the car body horizontal, the torque of the front wheels is increased, and the speed ff of the front wheels is increased, and the damper and spring are turned from the normal state to the soft state. Thereby, the front wheel arms 20 perform the swing motion so as to increase the arm angle θf of the front wheels, and the arm angle θf is controlled until the car body posture turns to a horizontal state. At this time, the damper and spring of the rear wheels are switched to the hard state from the normal state, and the car body height on the rear wheel side is held.

As shown in (3) in FIG. 10, when the arm angle of the front wheels reaches the limit, to keep the car body horizontal, the rear wheel torque is increased, and the damper of the rear wheels is put into the soft state. By doing this, the arm angle θf of the rear wheels is reduced (rear side is raised). Next, using the learned control pattern of the front wheels which is stored in memory, when the rear wheels start to go up the slope, the front torque and rear torque are increased according to the slope of the road surface so as to keep the speed of the front and rear wheels at the target value.

During going up the slope, as shown in (4) in FIG. 10, to keep the car body horizontal and go up the slope at the target car speed, the operations in (2) and (3) are performed repeatedly (the drawing of (4) in FIG. 10 shows that the arm angle is limited).

As shown in (5) in FIG. 10, when the front wheels approach the flat road surface, the number of revolutions of each front wheel motor is increased in the same state as that of the previous front wheel motor torque, so that from the relationship between the motor torque and the number of revolutions of the motor, the end of going up the slope is recognized. In this case, the front wheel torque is reduced, and the damper and spring are switched from the normal state to the soft state. So that the front wheel speed is reduced, thus the arm angle θf of the front wheels is reduced. Further, the end point of going up the slope is presumed by the trace pattern of the front wheels. And when the rear wheels reach the end point of going up the slope, to prevent unnecessary acceleration, the rear wheel torque is reduced to the flat road torque (however, the damper and spring are made harder than the normal hardness, thus the height of the rear side of the car body is kept a present state). Thereby, the car body clearance (the minimum height from the ground to chassis) can be reserved.

By doing this, as shown in (6) in FIG. 10, at the time of ending of going up the slope, the car height is higher than that in the normal state.

Thereafter, as shown in (7) in FIG. 10, the following control, namely front wheel torque increase front wheel speed increase→front wheel arm angle increase→front car body height recovery (car height decrease)→stationary traveling state, rear wheel torque reduction→rear wheel speed reduction→rear wheel arm angle increase→rear car body height recovery (car height decrease)→stationary traveling state, are performed.

Further, in the above car body posture control, the posture control in the longitudinal direction of the car body during traveling is indicated. However, the posture control in the lateral direction of the car body during traveling is made possible by the following operation.

For example, (1) when the car body is to be inclined in the lateral direction and either of the left and right car heights is to be lowered, the revolution speed and torque of the front wheel-in motor on the side of the car height to be lowered are made larger than the revolution speed and torque of the front wheel-in motor on the side of the car height not to be lowered, and the revolution speed and torque of the rear wheel-in motor on the side of the car height to be lowered are made smaller than the revolution speed and torque of the rear wheel-in motor on the side of the car height not to be lowered, and

(2) when the car height of either of the left and right sides of the car body is to be increased, the revolution speed and torque of the front wheel-in motor on the side of the car height to be increased are made smaller than the revolution speed and torque of the front wheel-in motor on the side of the car height not to be increased, and the revolution speed and torque of the rear wheel-in motor on the side of the car height to be increased are made larger than the revolution speed and torque of the rear wheel-in motor on the side of the car height not to be increased.

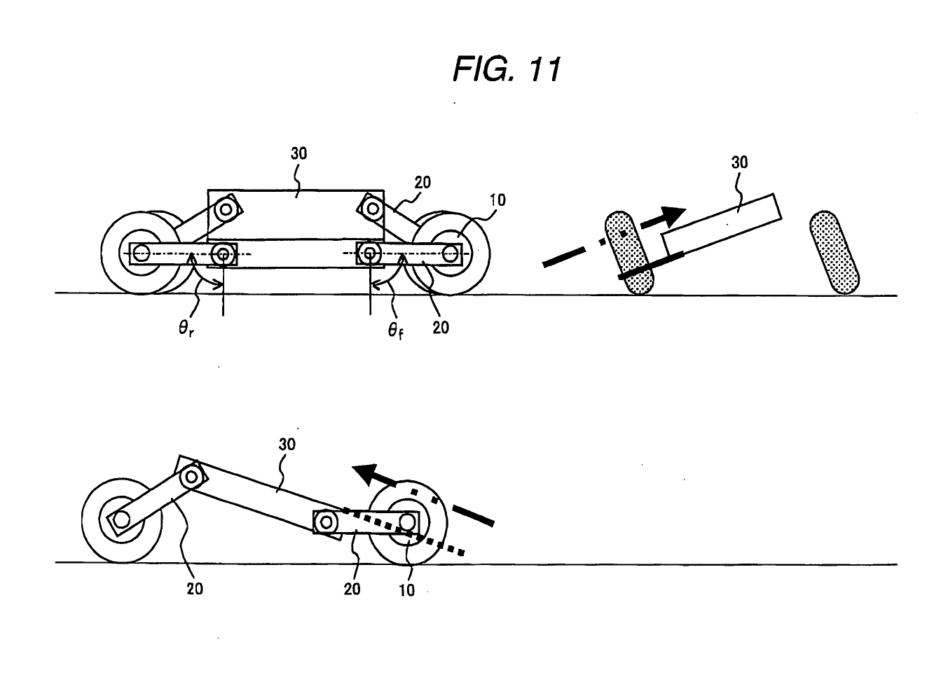

FIGS. 11 to 14 show other car body posture control methods using this embodiment.

FIG. 11(a) shows an example of side (the lateral direction of the car body) slant control during stop.

In FIG. 11(a), among the left and right wheels, the arm angles Of and Or of the arms 20 of the front and rear wheels on one side (the side that the car body is to be lowered) are controlled so as to form 90° (that is, the arm opening motion to form θf+θr=180°) on the basis of the perpendicular line of the car shaft. And another (the side that the car body is to be raised) arms 20 keep the arm angles that θf+θr is smaller than 180°. Such control can be realized, for example during stop of the car, by opening the orifice 46 of each damper 42 of the arms 20 on the side that the car body is lowered (the damper is opened), and by putting each damper of the arms 20 on the side that the car body is raised into the rigid body state by closing the orifice 46. Namely, when the dampers on the side that the car body is lowered are opened, since the arms 20 of the front and rear wheels on the opened damper side cannot support the weight of the car body 30, the arms 20 are opened in the longitudinal direction. Thus the car body 30 is inclined in the lateral direction.

When the car body is stopped in the state that the ordinary car height (normal state) is held, every damper is set into the rigid state by closing each orifice 46.

Further, with respect to such a side slant control of the vehicle, when additionally making the front wheel (which is one on the side to be lowered) rotate in the forward direction and making the rear wheel (which is one on the side to be lowered) is rotate in the backward direction, high speed side slant control is made possible.

By such a side slant, a getting on and off step of a bus can be formed as a non-step.

FIG. 11(b) shows an example of a rear slant. In this case, it can be realized by opening the dampers of only the rear wheels and rotating the rear wheels in the backward direction. The rear slant can be applied, for example, to loading and unloading goods from a truck.

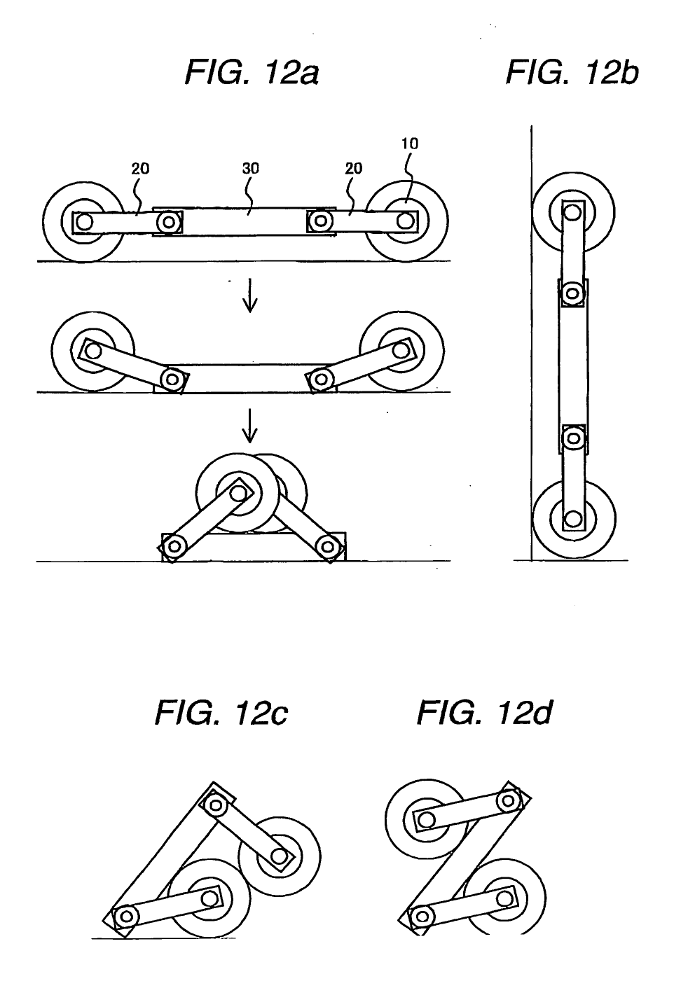

Furthermore, various parking and storing postures as shown in FIG. 12 can be taken up. For example, when as shown in FIG. 12(a), the dampers of all the arms 20 of the front and rear wheels are opened and the swing arms 20 are fully opened, finally, the car body 30 is put into the state that it lies down on the road surface by its own weight. Furthermore, the arms 20 are folded up in the direction of the car body 30 against spring force, thereby can be folded up.

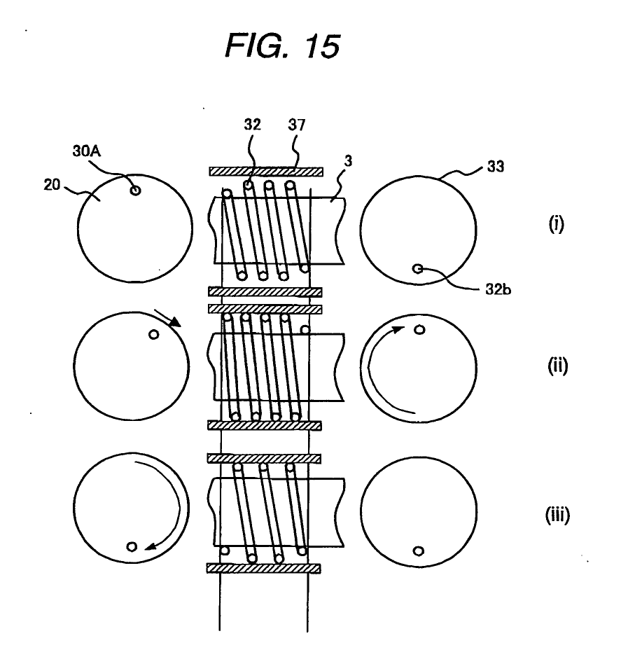

FIG. 15 shows the behavior of the spring 32 when the operation shown in FIG. 12(a) is made possible. The basic structure of the spring 32 is similar to that of the spring unit 31 shown in FIG. 3. Here, in addition to the structure shown in FIG. 3, moreover a sleeve 37 is arranged around the coil spring 32. Inside the sleeve 37, as shown in (i) to (iii) in FIG. 15, when the spring 32 is twisted from the neutral state in (i) to the opposite phase ((ii) or (iii)), the spring 32 can slide. The operation in (i) in FIG. 12 is accompanied by twisting of the spring 32 in the opposite phase, and when the pivot 3 is rotated so that the spring 32 is put into the opposite phase as shown in (ii) and (iii), the spring 32 is restricted inside the sleeve 37, and the supporting point 32A on the side of the arm 20 is twisted, and force (wind up) to swing up the arm 20 is generated.

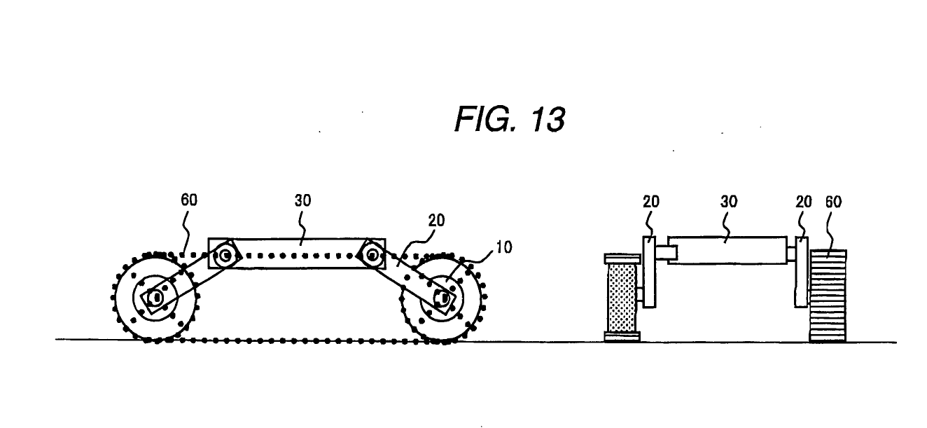

Further, as an application of FIG. 12(a), as shown in FIG. 12(b), the arm 20 is opened and the car body is turned upside down or the postures shown in FIGS. 12(c) and 12(d) can be taken up. Furthermore, the present invention can be applied to a car with a crawler as shown in FIG. 13 mounted.

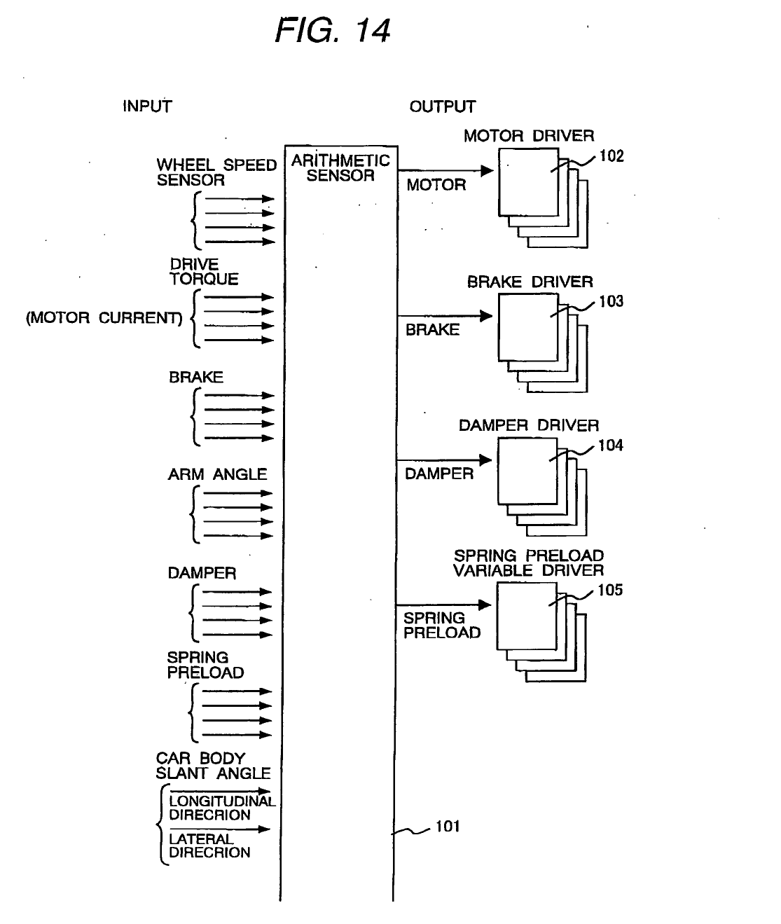

FIG. 14 is a block diagram of a controller when the car body posture control of the aforementioned embodiment is performed.

An arithmetic unit 101 of the controller inputs signals from the wheel revolution speed sensor (wheel speed sensor), drive torque sensor (motor current sensor), brake sensor, arm angle sensor, and car body slant angle sensor. The arithmetic unit 101 judges the traveling state of the road surface at least from the wheel revolution speed sensor and drive torque sensor, outputs, according to it, a speed instruction to the motor driver of each wheel-in motor of the front and rear wheels, moreover outputs a control instruction to a damper driver 104 and a spring preload variable driver 105, and executes the aforementioned car body posture control. Numeral 103 indicates a brake driver.

According to this embodiment, various types of car body posture control can be performed according to the road surface state and moreover, by controlling the suspension damper and spring according to the road surface state and the load under the spring of each wheel-in motor, the traveling ability and comfortableness to ride in a car of a wheel-in motor system can be improved.

In a car of a wheel-in motor system, according to the road state, the spring and damper can be variably controlled and the car body posture can be controlled.

1. A suspension for a vehicle comprising:
a wheel-in motor which is equipped with a motor provided in a wheel and an output shaft of the motor rotating with the wheel, and
an arm for suspending a car body, wherein
one end of the arm is fixed to the car body with a pivot to perform a swing motion in the longitudinal direction of the car body, another end of the arm is connected to the output shaft of the motor so as to rotate relatively to the output shaft.

2. The suspension according to claim 1,
further comprising a swing control mechanism for controlling the swing motion of the arm during traveling of the car.

3. The suspension according to claim 1,
further comprising a spring and a damper for absorbing vibration transmitted to the car body via the wheel-in motor and the arm, wherein the damper has a function for controlling the swing motion of the arm.

4. The suspension according to claim 1, wherein
a damper and a spring for a shock absorber is provided at the pivot of the arm;
the spring is a coil spring, which is arranged around the pivot so as to be twisted against the swing motion of the arm.

5. The suspension according to claim 1, wherein
a damper and a spring for a shock absorber is provided at the pivot of the arm;
the spring is a coil spring, which is arranged around the pivot so as to be twisted against the swing motion of the arm; and
a load of the spring is applied adjustably beforehand with a spring load adjusting mechanism.

6. The suspension according to claim 1, wherein a damper and a spring for a shock absorber is provided between the arm and the car body.

7. The suspension according to claim 1, wherein the wheel has a built-in brake unit driven by an electric signal.

8. The suspension according to claim 1, further comprising a wheel speed sensor for detecting a wheel speed, an arm angle sensor for detecting an angle of the arm, a torque sensor for detecting torque of the motor, and a body angle sensor for detecting a tilt of the car body.

9. A vehicle control method comprising:
using each suspension having the arm and the wheel-in motor in claim 1 an independent suspension system of a car body;
controlling a posture of the car body during traveling of the car by at least controlling a revolution speed and a torque of each wheel-in motor of front wheels and rear wheels, and controlling the swing motions of the arm of each suspension of front wheels and rear wheels in the longitudinal direction of the car body.

10. The vehicle control method according to claim 9, wherein a posture of the car body is controlled during traveling of the car by controlling a response of the swing motion of each arm according to a state of a road surface, and by controlling an angle of the arm by controlling the revolution speed and the torque of each wheel-in motor.

11. The vehicle control method according to claim 9, wherein during traveling of the car, (1) when the height on the front side of the car body is to be lowered, the revolution speed and the torque of the wheel-in motors on the front wheel side are made larger than those of the wheel-in motors on the rear wheel side, and (2) when the height on the rear side is to be lowered, the revolution speed and the torque of the wheel-in motors on the rear wheel side are made smaller than those of the wheel-in motors on the front wheel side, and (3) when the car height on the front side is to be increased, the revolution speed and the torque of the wheel-in motors on the front wheel side are made smaller than those of the wheel-in motors o the rear wheel side, and (4) when the height on the rear side is to be increased, the revolution speed and the torque of the wheel-in motors on the rear wheel side are made larger than those of the wheel-in motors on the front wheel side.

12. The vehicle control method according to claim 9, wherein during traveling of the car, (1) when the height of either of the left and right sides of the car body is to be lowered, the revolution speed and the torque of the front wheel-in motor on the side of the height to be lowered are made larger than the revolution speed and the torque of the front wheel-in motor on the side of the height not to be lowered, and the revolution speed and the torque of the rear wheel-in motor on the side of the height to be lowered are made smaller than the revolution speed and the torque of the rear wheel-in motor on the side of the height not be lowered, and
(2) when the height of either of the left and right sides of the car body is to be increased, the revolution speed and the torque of the front wheel-in motor on the side of the height to be increased are made smaller than the revolution speed and the torque of the front wheel-in motor on the side of the height not to be increased, and the revolution speed and the torque of the rear wheel-in motor on the side of the height to be increased are made larger than the revolution speed and the torque of the rear wheel-in motor on the side of the height not to be increased.

13. A vehicle control apparatus comprising:
a wheel-in motors which is provided in each wheel of front and rear wheels and has an output shaft rotating with the wheels;
an arm of each one of front and rear suspensions for suspending a car body, wherein one end of the arm is fixed to the car body with a pivot to perform a swing motion in the longitudinal direction of the car body, another end of the arm is connected to the output shaft of the motor so as to rotate relatively to the output shaft; and
an arm angle control unit for controlling a revolution speed and a torque of each wheel-in motor to control an angle of the arm.

14. The vehicle control apparatus according to claim 13, further comprising a control mechanism for controlling a response of the swing motion of the arm,
and when controlling an angle of the arm, the response of the swing motion are controlled to be more rapid than usual traveling.

15. A suspension for a vehicle comprising:
a wheel-in motor which is equipped with a motor provided in a wheel and an output shaft of the motor rotating with the wheel, and
an arm for suspending a car body, wherein
one end of the arm is fixed to the car body with a pivot to perform a swing motion in the longitudinal direction of the car body, another end of the arm is connected to the output shaft of the motor with at a bearing mechanism.
